(19) United States
(12) Patent Application Publication
(10) Pub. No.: US 2013/0096838 A1
(43) Pub. Date: Apr. 18, 2013

(54) Gene Splicing Defects

(71) Applicant: William Fairbrother, Barrington, RI (US)

(72) Inventor: William Fairbrother, Barrington, RI (US)

(21) Appl. No.: 13/493,863

(22) Filed: Jun. 11, 2012

Related U.S. Application Data
(60) Provisional application No. 61/495,826, filed on Jun. 10, 2011.

(51) Int. Cl. G06F 19/10; G06F 17/16

(52) U.S. Cl. CPC G06F 19/10; G06F 17/16
USPC 702/19

(57) ABSTRACT

Predicting the effect of a mutation in a nucleic acid sequence on splicing is accomplished by determining the distance between at least two nucleic acid sequence positional distributions and providing a prediction of impact on splicing function based on at least the distance. A low distance indicates there is little or no difference in splicing function compared to a normal control. A high distance indicates a difference in splicing function. Related apparatus, systems, techniques and articles are also described.

### CROSS REFERENCE TO RELATED APPLICATIONS

This application claims the benefit of U.S. Provisional Application No. 61/495,826, filed on Jun. 10, 2011, the contents of which are incorporated herein by reference.

### TECHNICAL FIELD

The subject matter described herein relates to the field of computing gene splicing defects.

### BACKGROUND

Before a messenger ribonucleic acid can produce a proper protein through translation, nucleic acid introns are removed and exons are joined together in a process referred to as “splicing.” Errors in nucleic acid splicing cause disruptions in the open reading frame, insertion or deletion of amino acids, or deletion of entire exon coding sequences. These mutant proteins are responsible for hundreds of diseases, including hereditary diseases. As such, there is a pressing need for new strategies to identify and treat patients with splicing mutations.

### SUMMARY

In one aspect predicting the effect of a mutation in a nucleic acid sequence on splicing is accomplished by determining the distance between at least two nucleic acid sequence positional distributions and providing a prediction of impact on splicing function based on at least the distance. A low distance indicates there is little or no difference in splicing function compared to a normal control. A high distance indicates a difference in splicing function.

In another aspect, data is received characterizing a first nucleic acid sequence, a second nucleic acid sequence, a positional distribution of the first sequence relative to a splice site, and a positional distribution of the second sequence relative to the splice site. A distance between the positional distribution of the first sequence and the positional distribution of the second sequence is computed. The second sequence is a mutation of the first sequence. The distance is provided.

In yet another aspect, alignments of nucleotides surrounding all 3′ and 5′ splice sites are created. The number of occurrences of all polymers is counted. For each polymer, a feature vector is constructed by concatenating counts from the 3′ splice site alignment and the 5′ splice site alignment. The counts are normalized in each entry of each feature vector. The feature vectors are clustered and the number of clusters is determined.

In yet another aspect, identifying a candidate subject for repair of a gene splicing defect associated with a pathological condition is accomplished by providing a plurality of nucleic acid sequences obtained from or derived from an individual or a gene mutation database sequence and at least one corresponding mutation for each nucleic acid sequence. A positional distribution of each of the plurality of nucleic acid sequences and the at least one corresponding mutation is provided. A distance between each of the nucleic acid sequence positional distributions and the at least one corresponding mutation positional distribution is determined. A low distance indicates there is little or no difference in splicing function. A high distance indicates a splicing mutation in the nucleic acid sequence and identifies the individual as a candidate for repair of the gene splicing defect.

One or more of the following features can be included. The distance is considered high when the distance is greater than about 95% of distances between a representative set of nucleic acid sequence positional distributions that can occur through the process of a single point mutation. The nucleic acid sequences can comprise a messenger ribonucleic acid (mRNA) sequence, pre-mRNA sequence, cDNA sequence, or genomic DNA sequence. The distance can be a L1 distance, computed according to:

$$d ( p , q ) = {\sum }_{i = 1}^{n} \vert {p}_{i} - {q}_{i} \vert$$

wherein p is a normalized count of one of the nucleic acid sequence positional distributions at position n, q is a normalized count of another of the nucleic acid sequence positional distributions at position n, and n is a genomic position relative to a splice site. The genomic position can be determined by a number of nucleotides in a sequence from the splice site. n can be between about 1 and about 600. The distance can be a Euclidian distance. The nucleic acid sequence positional distributions can include both intronic and exonic positions. The splicing mutation can be a point mutation or a missense mutation or a single nucleotide polymorphism. The distance can be an intra-allelic distance.

The splicing mutation can be a disease-causing splicing mutation. A likelihood the splicing mutation is a disease-causing splicing mutation can be determined. The length of each of the nucleic acid sequences can be between about 6 and about 10. The length of each of the at least two nucleic acid sequences can be 6. The nucleic acid sequence positional distributions can be computed from the genome of one or more of the following organisms: human, chimp, rhesus, mouse, rat, guinea pig, cat dog, chicken, X. tropicalis, and zebrafish.

The feature vector can be constructed according to:

$$∀ x ∈ \vec{x} , {x}^{′} = \frac{x - μ}{σ}$$

where x are the counts, μ is the average count in the region, and σ is the standard deviation. The clustering can include comparing all possible pairs of vectors, position by position, and returning a distance metric that is related to the closeness of the two vectors. The clustering can include using a distance metric to organize data into groups of similar vectors. The distance metric can be ranked and compared with a neighborhood inference set of exonic splicing enhancers. The length of each feature vector can be 600 nucleotides. The feature vectors can be clustered using a k-means algorithm and the distance metric. Exons of less than 200 nucleotides can be divided in half and assign it to the closest splice site. Introns of less than 400 nucleotides can be divided in half and assigned it to the closest splice site.

The individual can be suffering from, can be suspected of having, or can have a family history of a hereditary disease. The hereditary disease can include cancer, heart disease and stroke, diabetes, osteoporosis, depression, and Alzheimer's disease. The gene mutation database can include the Human Gene Mutation Database (HGMD). The cancer comprises breast, ovarian, colorectal, prostate, or skin cancer. The splicing mutations can be prioritized to predict clinical significance.

Many hereditary diseases are caused by defects in nucleic acid splicing rather than protein coding defects. Splicing defects are fixed more easily and safely than protein coding defects. However, prior to the invention, such processing defects were difficult and laborious to detect.

Articles of manufacture are also described that comprise computer executable instructions permanently stored (e.g., non-transitorily stored, etc.) on computer readable media, which, when executed by a computer, causes the computer to perform operations herein. Similarly, computer systems are also described that may include a processor and a memory coupled to the processor. The memory may temporarily or permanently store one or more programs that cause the processor to perform one or more of the operations described herein. In addition, methods can be implemented by one or more data processors either within a single computing system or distributed among two or more computing systems.

The subject matter described herein provides many advantages. Although any individual may choose to get tested, the methods and systems are particularly useful for diagnostic purposes for individuals who are suffering from, suspected of having, or have a family history of a hereditary disease such as cancer (e.g., breast, ovarian, colorectal, prostate, or skin cancer), heart disease and stroke, diabetes, osteoporosis, depression, and Alzheimer's disease. The invention is also useful to segregate or prioritize splicing mutations to predict clinical significance. It is often too costly and too expensive to go into the lab and test every sequence for detrimental effects. The methods described herein give genetic researchers a way to triage the many mutations that pique their curiosity, to see which ones are most likely to have a clinical effect.

As described herein, a processing defect is able to be detected and fixed much more easily and safely than a protein coding defect. Engineered proteins called “antisense oligos” have been used to interfere with errant splicing operations. However, an error in the genetic coding for a final product protein can only be addressed through difficult and risky therapies that attempt to replace a whole gene. Thus, described herein is a new type of therapy that is directed at reducing the processing defects. Moreover, an antisense oligo therapy that successfully fixed a splicing problem implicated in one disease could likely be easily adapted for fixing a splicing problem implicated in another disease.

The details of one or more variations of the subject matter described herein are set forth in the accompanying drawings and the description below. Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, Genbank/NCBI accession numbers, and other references mentioned herein are incorporated by reference in their entirety. In the case of conflict, the present specification, including definitions, will control. In addition, the materials, methods, and examples are illustrative only and not intended to be limiting. Other features and advantages of the subject matter described herein will be apparent from the description and drawings, and from the claims.

### DESCRIPTION OF DRAWINGS

FIG. 1 is a process flow diagram illustrating a method of predicting the effect of a mutation in a nucleic acid sequence on splicing;

FIG. 2 is a process flow diagram illustrating a method of computing a distance between positional distributions;

FIG. 3 is a process flow diagram illustrating a method of determining a positional distribution of a polymer relative to splice sites;

FIG. 4 is a process flow diagram illustrating a method for identifying a candidate subject for repair of a gene splicing defect associated with a pathological condition;

FIGS. 5A-C are illustrations showing that exonic binding of the intronic activator, U2AF65, inhibits splicing;

FIGS. 6A-C are illustrations showing clustering motifs according to their positional distribution around splice sites;

FIGS. 7A-C are illustrations showing minigene assay of element function which confirms splicing differences between wildtype cluster exemplars and predicted mutants;

FIGS. 8A-C are illustrations showing that human disease alleles are predicted to disrupt splicing;

FIG. 9 illustrates a nucleic acid sequence and the corresponding location count in the feature vector; and

FIG. 10 is an illustration of an example positional distribution feature vector.

Like reference symbols in the various drawings indicate like elements.

### DETAILED DESCRIPTION

Genetic diseases are linked to detectable and fixable gene splicing problems. As described herein, many more hereditary diseases than previously thought are caused, at least in part, by errors in pre-mRNA splicing. Research indicates it may be possible to fix bad splicing.

Disruption of pre-mRNA splicing is a common causal mechanism for many disease mutations. The ability to predict mutations that interfere with pre-mRNA splicing would allow for more targeted identification of candidate subjects for repair of the gene splicing defects. Additionally, a service which interprets the effects of mutations as it relates to disease could advance personalized medicine and aid in hereditary disease diagnosis related to a wide range of ailments such as cancer, heart disease, stroke, diabetes, osteoporosis, depression, and Alzheimer's disease. Further, fixing splicing sequences can be safer for the patient than changing protein sequencing.

As described in detail below, a computer analysis which predicts the effect of genetic mutations on how the body splices mRNA indicates as many as a third of disease-related mutations may be linked to splicing problems—more than double the proportion previously thought. Approximately 85 percent of the mutations in the HGMD are presumed to affect how proteins are coded; however, the results presented herein demonstrate that 22 percent of those are affecting the splicing process. Add that to the 15 percent already believed to affect splicing of mRNA, and nearly one in three mutations in the HGMD may owe at least part of their harmful results—hundreds of hereditary diseases—to the way in which they cause splicing errors.

### Splice Significance

Genes are sections of DNA sequence that provide the cell with the instructions, or code, for making the proteins that the body needs for all its functions. During this manufacturing process, useful protein coding sequences need to be cut out and reconnected—spliced—from longer sequences. The information necessary for the cell to join all the useful parts, or protein coding exons, together correctly is located within the sequence of that gene. Mutations that affect this splicing information are often very disruptive to gene function, causing entire exons to be lost from the final product. Despite this, a patient carrying a mutation that results in a faulty splicing may eventually have a brighter outlook than a patient who has mutations in the exons themselves.

### Predicting Problems

The computer program described herein analyzes, for example, the human genome and data on splicing operations. The program observes short sequences that occur many times in the genome. The locations of these multiple occurrences were informative about the function of the sequence. Sequences that help splicing often occur close to splice sites. As described in detail below, mutations that affected splicing created new sequence motifs that changed their distribution around splice sites in distinctive ways compared to mutations that did not affect splicing. The mathematical distance from the norm was quantified and calculated. The bigger the distance, the more likely the distance is involved in splicing.

The example program predicts which mutations from the HGMD should be examined in real lab experiments. In most cases, the computer program was correct about the effect the mutation would have on splicing. Mutations associated with diseases such as albinism and colorectal cancer were examined. As described below, these mutations do indeed cause splicing errors.

### Predicting the Effect of a Mutation in a Nucleic Acid Sequence on Splicing

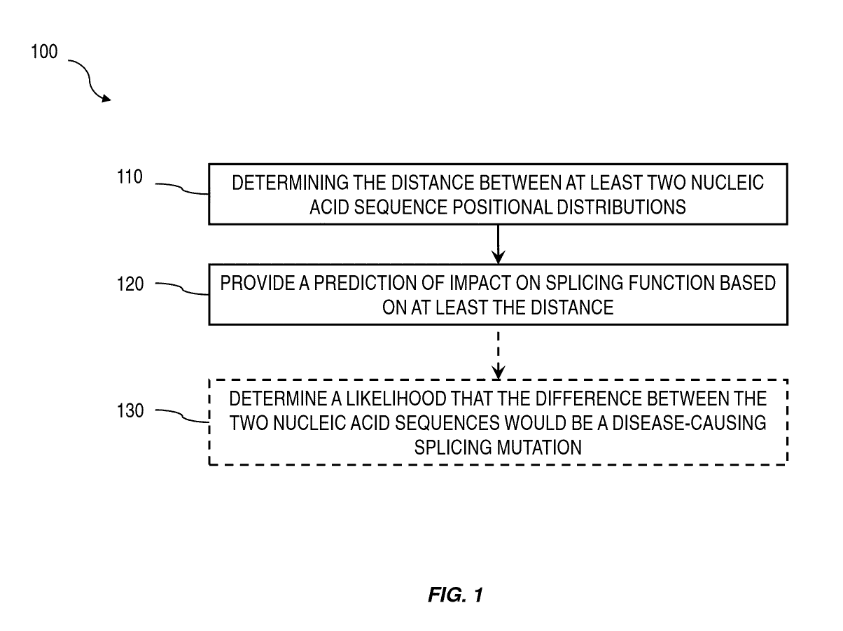

FIG. 1 is a process flow diagram 100 illustrating a method of predicting the effect of a mutation in a nucleic acid sequence on splicing. At 110, the distance between at least two nucleic acid sequence position distributions is determined. At 120, a prediction of the impact on splicing function based on at least the distance is provided. A low distance indicates there is little or no difference in splicing function compared to a normal control. A high distance indicates there is a difference in splicing function. A normal control can include one or more controls. Additionally, the normal control can be a representative set of nucleic acid sequence positional distributions that can occur through the process of one or more point mutations. Alternatively, the mutations can include deletion, substitution, insertion and inversion mutations. Optionally, at 130, a likelihood that the difference between the two nucleic acid sequences would be a disease-causing splicing mutation can be determined.

The nucleic acid sequences can include a messenger ribonucleic acid (mRNA) sequence, pre-mRNA sequence, cDNA sequence, and/or genomic DNA sequence. The mutation can be a splicing mutation such as a point mutation, a missense mutation, or a single nucleotide polymorphism. Also, the mutation can be a disease-causing splicing mutation.

The distance between the nucleic acid sequence positional distributions can be computed using an L1 (also known as a 1-norm or “Manhattan distance”) computed according to:

$$d ( p , q ) = {\sum }_{i = 1}^{n} \vert {p}_{i} - {q}_{i} \vert$$

wherein p is a normalized count of a first polymer at position n, q is a normalized count of a second polymer at position n, and n is a genomic position relative to a splice site. The distance can also be the Euclidean distance (or 2-norm). The distance can further be an intra-allelic distance. The genomic position is determined by the number of nucleotides in a sequence between the current position and the nearest splice site. The genomic position can be, for example, between about 1 and about 600.

The positional distributions can include both intronic and exonic positions and can be computed from portions of or all of the genome of one or more of: human, chimp, rhesus, mouse, rat guinea pig, cad, dog, chicken, X. tropicalis, and zebrafish. The sequences used to compute the positional distributions can be between about 6 and 10 nucleotides in length.

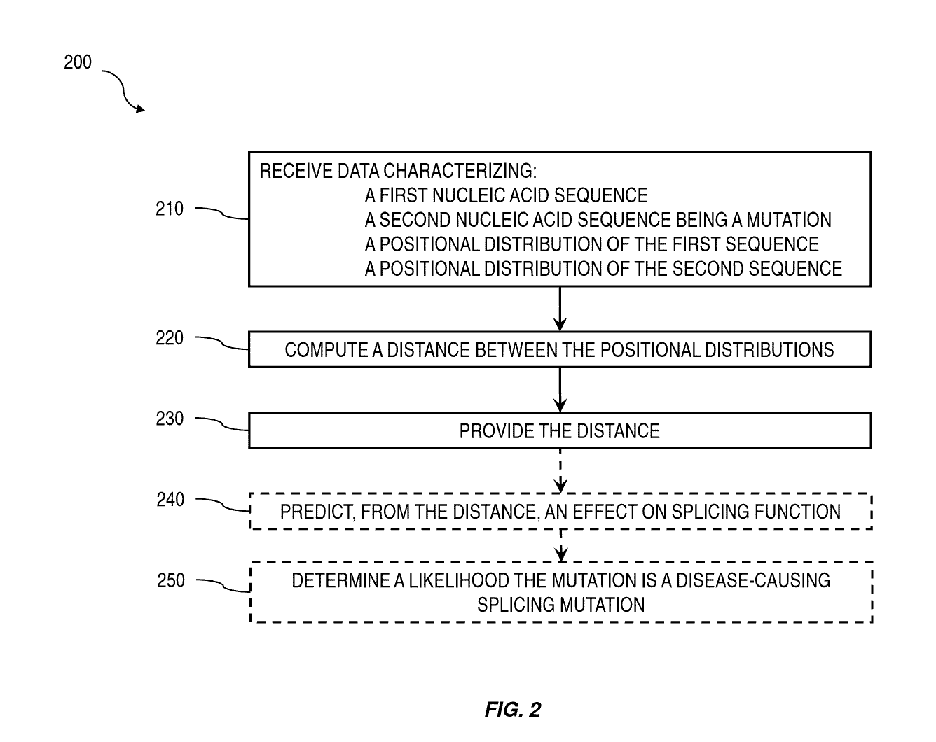

FIG. 2 is a process flow diagram 200 illustrating the steps of executable instructions stored on a non-transitory computer readable medium. At 210, data characterizing a first nucleic acid sequence, a second nucleic acid sequence, a positional distribution of the first sequence and a positional distribution of the second sequence is received. The second sequence can be a mutation of the first sequence. The mutations can include a splicing mutation such as a point mutation, a missense mutation, or a single nucleotide polymorphism. Also, the mutation can be a disease-causing splicing mutation. At 220, a distance between the positional distributions can be computed. This distance expresses a “closeness” between the positional distributions. At 230, the distance is provided. Optionally, at 240, a prediction on the effect of the mutation on splicing function can be made from the distance. A low distance indicates that there is little or no difference in splicing function when compared to a normal control. A high distance indicates a difference in splicing function. Optionally, at 250, a likelihood the mutation is a disease-causing splicing mutation can be determined.

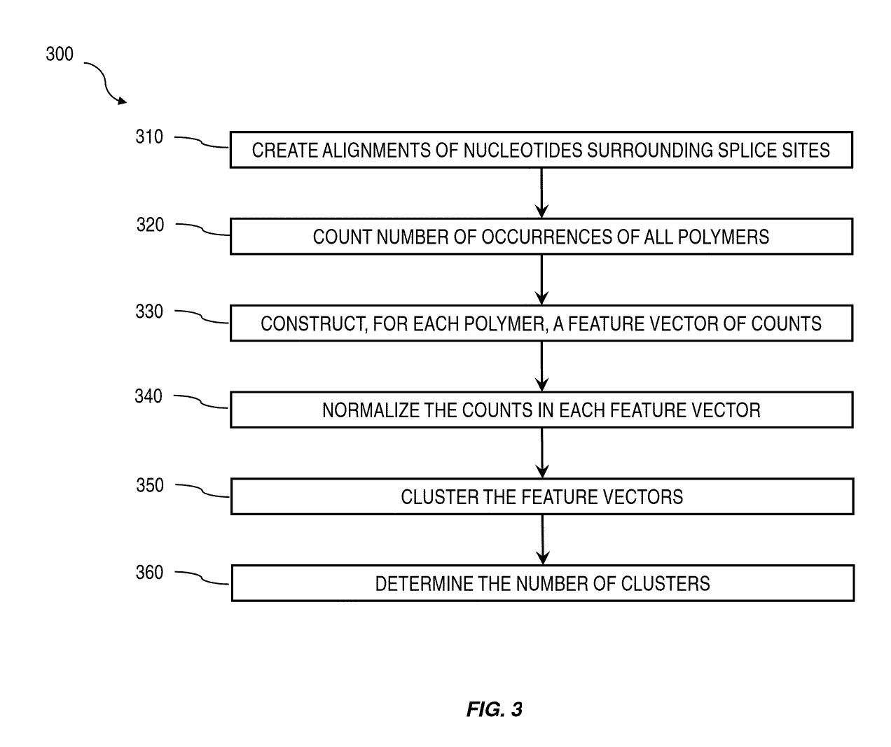

FIG. 3 is a process flow diagram 300 illustrating a computer implemented method of determining a positional distribution of a polymer relative to splice sites. At 310, alignments of nucleotides surrounding all 3′ and 5′ splice sites are created. At 320, the number of occurrences of all polymers is counted. The polymers can be, for example, between 6 and 10 sequences in length. For example, if the polymers were 6 nucleotides in length, then in total there would be 4,096 total possible polymers (i.e. hexamers). At 330, for each polymer, a feature vector of counts is constructed. The feature vector includes the positional distribution of the polymer relative to both the 3′ and 5′ splice sites. At 340, the counts in each feature vector are normalizes. The normalization can be computed according to:

$$∀ x ∈ \vec{x} , {x}^{′} = \frac{x - μ}{σ}$$

where x are the counts, μ is the average count in the region, and σ is the standard deviation. The length of each feature vector can be, for example, 600. If an exon is less than 200 nucleotides or an intron is less than 400 nucleotides, the sequence can be divided in half and assigned to the closest splice site.

At 350, the feature vectors are clustered. The clustering can include comparing all possible pairs of vectors (for example, all 4,096 in the case of hexamers), position by position, and returning a distance metric that is related to the closeness of the two vectors. A k-means algorithm can be used to organize data into groups of similar vectors based on the distance metric. The distance metric can be a Euclidean distance, an L1 distance, or any other suitable metric. At 360, an optimal number of clusters can be determined based on the performance of the clustering step. Optionally, the distance metric can be ranked and compared to a neighborhood inference set of exonic splicing enhancers.

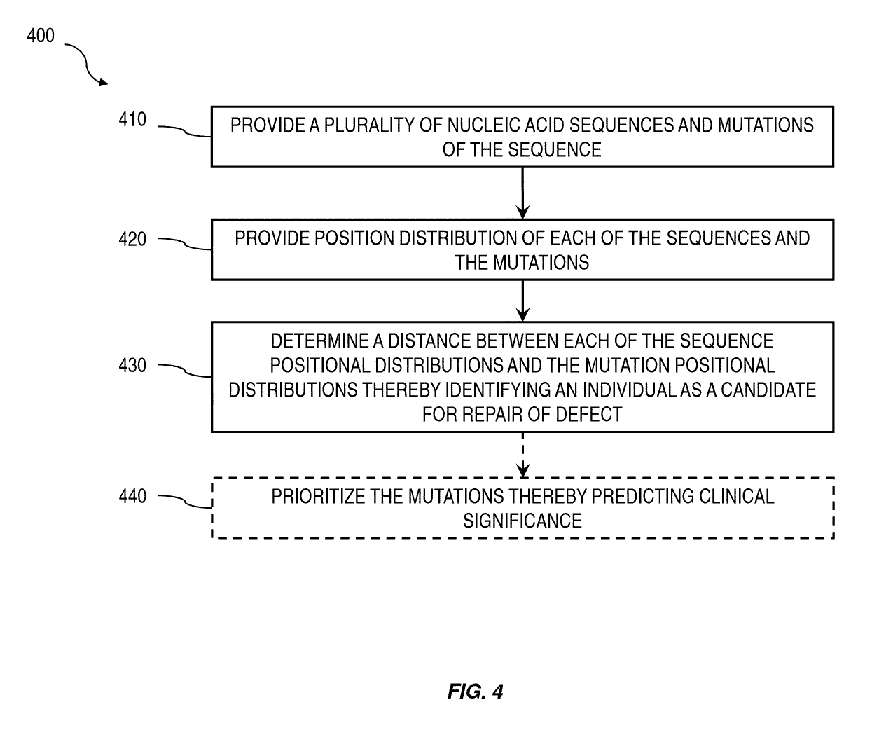

FIG. 4 is a process flow diagram 400 illustrating a method for identifying a candidate subject for repair of a gene splicing defect associated with a pathological condition. At 410, a plurality of nucleic acid sequences and corresponding mutations of the sequences are provided. At 420, the positional distributions of each of the sequences and the mutations are provided. At 430, a distance between each of the sequence positional distributions and the mutation positional distributions is determined. A low distance indicates there is little or no difference in splicing function. A high distance indicates a splicing mutation in the nucleic acid sequence. A candidate for repair of the gene splicing defect can be identified. Optionally, at 440, the mutations can be prioritized to predict clinical significance.

The individual can be suffering from, suspected of having, or has a family history of a hereditary disease. The hereditary disease can include cancer, heart disease, stroke, diabetes, osteoporosis, depression, and Alzheimer's disease. The cancer can include breast, ovarian, colorectal, prostate, and/or skin cancer. One or more of the nucleic acid sequences can be obtained or derived from an individual or a gene mutation database such as the HGMD.

### Example 1

An intuitive strategy for predicting the effect of sequence variation on splicing is presented. In contrast to transcriptional elements, splicing elements appear to be strongly position dependent. It is demonstrated that exonic binding of the normally intronic U2AF65 inhibits splicing. Reasoning that the positional distribution of a splicing element is a signature of its function, a method is developed for organizing all possible sequence motifs into clusters based on the genomic profile of their positional distribution around splice sites. Binding sites for SR proteins tended to be exonic while hnRNP recognition elements were mostly intronic. In addition to the known elements, novel motifs were returned and validated. This method was also predictive of splicing mutations. A mutation in a motif creates a new motif that sometimes has a similar distribution shape to the original motif and sometimes has a different distribution. An intra-allelic distance measure is created to capture this property and it is found that mutations that created large intra-allelic distances disrupted splicing in vivo whereas mutations with small distances did not alter splicing. Analyzing the dataset of human disease alleles reveals known splicing mutants to have high intra-allelic distances and suggested that 22% of disease alleles that were originally classified as missense mutations may also affect splicing. This category together with mutations in the canonical splicing signals suggests that approximately one third of all disease causing mutations alter pre-mRNA splicing.

Splicing is catalyzed by the spliceosome, a riboprotein complex that rivals the ribosome in size and complexity. The ribosome has a large and small subunit whose assembly on the mRNA substrate corresponds to a functional switch from initiation to elongation. The spliceosome is composed of five subunits that appear to exist in at least four different stable configurations and, like the ribosomal subunits, transition between different assembled states corresponding to different stages of function. Mass spectroscopy has identified at least 300 RNA and protein components in this catalytic complex and studies have demonstrated heterogeneity in spliceosomal complexes isolated from different splicing substrates. The spliceosomal components recognize the basic cis-elements of the splicing process. The spliceosome assembles and re-organizes on these elements is understood. However, several computational analyses estimate that these basic splicing elements contain at most half the information necessary for splice site recognition. The remaining information lies outside these splice sites presumably as enhancers or silencers.

This information required to specify splicing presents a considerable mutational target—estimates of the fraction of disease mutations that affect splicing range from 15% to 62%. Transcript analysis of genotyped cell lines has discovered numerous cases of allelic splicing demonstrating that polymorphisms also disrupt splicing. These types of functional variants likely account for a similarly large fraction of the detected genetic risk for complex disease and could eventually be a target for molecular intervention. As physical methods for the detection of alternative splicing require large panels of genotyped accessible tissue, these studies will probably continue to be limited to samples harvested from human blood. An alternate approach is the prediction of causative variations from SNPs that fall within splicing elements. The key to this approach is being able to identify what the splicing elements are and whether a variation is disruptive.

Recently, a variety of experimental and computational methods have emerged to identify sequence elements capable of functioning as enhancers and silencers. Considerable data has been gathered on the proteins that recognize these elements. The prototypical splicing activator that recognizes exonic splicing enhancers is one of the SR proteins. The hnRNP family of proteins has generally been regarded as repressors as they inhibit splicing when bound to exons in pre-mRNA. However, hnRNP A, B, C, F and H stimulate splicing when bound at intronic positions. Conversely, SR proteins do not always promote splicing; SR proteins bound at intronic positions tend to function negatively in splice site recognition, a fact exploited by several viral alternative splicing systems. Experiments that relocated these intronic silencers into exons converted them into enhancers, and the reverse experiment of moving a natural ESE into an intronic location resulted in splicing repression. Positional effects on function appear at a finer scale than binning sequence into intron versus exon. Indeed an element's location within an exon can also affect its function. This notion that an element's activity is a function of its position has led to the routine use of “RNA maps” in crosslinking immunoprecipitation (CLIP) studies. An RNA map separates immunoprecipitated tags that fall around positively regulated exons from tags that fall around negatively regulated exons and plots the location of each tag set relative to the regulated splice site. In the genome-wide CLIP studies of hnRNP C, nova and Fox 1/2 specificity, the RNA maps illustrate that function differs according to positional distribution.

The relationship between location and function is exploited as a discovery tool. It is shown that splicing elements have signature positional distributions around constitutively spliced exons—they are abundant where they function positively and rare where they are inhibitory. Thus in a dataset of successful splicing events an element's positional distribution is a proxy measure for where it enhances splicing. As different types of elements will have different positional distributions, it is hypothesized that different positional distributions will define different splicing elements. Here, the development of this discovery tool is described. All possible hexamers are mapped around splice sites. 51 types of positional distributions (splicing elements) is discovered and it is demonstrated that these are predictive of function in vivo. It is found that mutations that create new hexamers with radically different positional distributions are more likely to cause striking differences in splicing in vivo. This tool is used to analyze disease alleles within the human population.

### Example 1

### Results

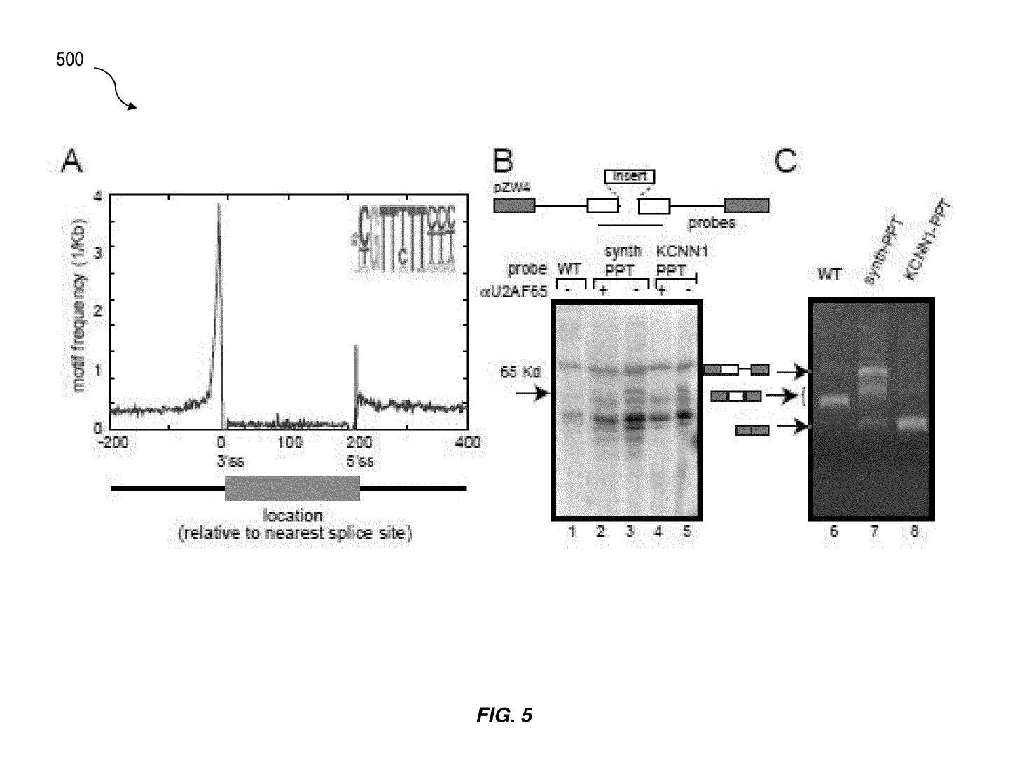

The splicing activator, U2AF65, inhibits splicing when bound at an exonic site. To test the relationship between the function of a splicing factor and the location of its predicted binding element, on one well-characterized factor-ligand binding event was initially focused on, U2AF65's recognition of the polypyrimidine tract. The binding motif consists of a Poly U-rich tract that typically contains runs of four or five uridines followed by cytosine frequently initiated with a G. This can be illustrated in FIG. 5A. Mapping U2AF65's binding motif across all exons revealed the largest peak occurring immediately upstream of the 3′ss. This location was consistent with its role as the principal recognizer of the polypyrimidine tract. The U2AF motif was overrepresented in the regions where it was known to function positively (i.e. in 3′ss recognition) and depleted in the exon (where U2AF binding has not been shown to support the normal spliceosomal complex). This suggested that the positional distribution pattern of an element around the splice sites was indicative of the trans-acting factor's function in splicing.

FIG. 5A-C are illustrations showing that exonic binding of the intronic activator, U2AF65, inhibits splicing. FIG. 5A shows SELEX motifs mapped to a dataset of 312,275 human splice site regions and plotted on an amalgamated exon. FIG. 5B shows the synthetic polypyrimidine tract returned by the SELEX consensus U2AF65 motifs and a genomic polypyrimidine tract were ligated into an exon and tested for U2AF65 binding by UV crosslinking in extract without antibody (lane 1, 3 and 5) or in extract that was blocked by an anti U2AF65 antibody (lane 2 and 4). The radiolabel transferred to several products of differing mobility—a 65 kD interaction that was sensitive to pre-incubation with antiU2AF65 antibody is indicated with an arrow. FIG. 5C includes the sizes of RT-PCR products reflecting varying degrees of splicing are shown by the arrows. The disruptive effects of ligating the synthetic and natural PPT into the test exon of pZW4 is shown by RT-PCR in lane 7 and 8.

To experimentally test the role of the binding location of a particular factor in splicing function, the normally positive-acting intronic U2AF65 binding site is relocated into an exonic location and assayed splicing. For this study two polypyrimidine tracts was utilized. One tract was a synthetic consensus U2AF65 binding site derived from a SELEX study and another was a natural polypyrimidine tract located upstream of the 3′ss of exon 5 of the KCNN1 gene. UV crosslinking indicated that numerous cellular proteins contacted both probes after incubation. The 65 kD interaction was blocked by pre-incubation with anti-U2AF65 antibodies thereby establishing specific U2AF65 contacts with the polypyrimidine tract with both of these inserts (FIG. 5B lanes 2 and 4 compared to no antibody control lanes 3 and 5) but not in the “no insert” control (FIG. 5B, lane 1).

The sequences used to probe binding were then assayed for function in the test exon of pZW4, an in vivo splicing reporter. The splicing phenotype was assayed by RT-PCR from total RNA following transfection into 293 cells. While the “no insert” control spliced normally, both reporters containing U2AF65 binding elements exhibited evidence of disrupted splice site recognition by skipping exon 2 in some fraction of the transcripts observed. The polypyrimidine tract from the KCNN1 gene also generated an intron inclusion product and several other aberrant species that were not characterized. This result demonstrated that U2AF65, a factor with a well-characterized role of activating splicing when bound in the intron, disrupts splicing when bound in the exon.

To determine if the relationship observed between U2AF65 binding and its function was general, the analysis was expanded to some members of the SR and hnRNP protein family. As SR proteins are generally regarded as activators that function by binding exonic splicing enhancers, the positional distribution was derived of the in vitro SELEX-derived position weight matrix (PWM) for three SR proteins: ASF/SF2, SC35, and 9G8. Three hnRNP proteins were also analyzed: hnRNP A1, hnRNP L, and hnRNP C. This analysis largely supported the role of SR proteins as activators that bind ESEs while hnRNP binding sites are located at predominantly intronic locations. Binding motifs for hnRNP C were concentrated around the 3′ss consistent with early reports of the location of hnRNP C dependant functional elements. hnRNP L and hnRNP A1 also bound intronic elements albeit further away from the splice sites. The analysis of the binding sites of known splicing factors revealed a non-uniform positional distribution that was indicative of their function.

If the position of a splicing motif relative to a splice site is a signature of that motif's function in splicing, then motifs with similar positional distributions should play similar roles in splicing and motifs with different positional distributions should play different roles in splicing. Therefore, by clustering the motifs according to their positional distribution around splice sites, it can be expected to organize elements into distinct functional classes.

Clustering words by positional distribution recovers splicing elements. An algorithm is developed to cluster sequence motifs according to their positional distribution around splice sites. The frequency of every possible sequence motif around all the annotated splice sites in the human genome is first tabulated. This was accomplished by mapping 4096 hexamers (6 nucleotide polymers) to all three hundred nucleotide windows around annotated 3′ splice sites (3′ss). This mapping associated each hexamer with a vector that contained the genomic occurrence of that hexamer at each position around all the 3′ss. This 300 unit long vector had a first position of −200 and a last position of +99 relative to the 3′ss. Counts were normalized to enable comparisons between hexamer positional distributions based on shape and not frequency. Repeating this procedure for the regions around the 5′ splice sites (5′ss) created a second vector which together with the 3′ss vector were used to summarize the positional distribution of hexamers around exon junctions in the human genome.

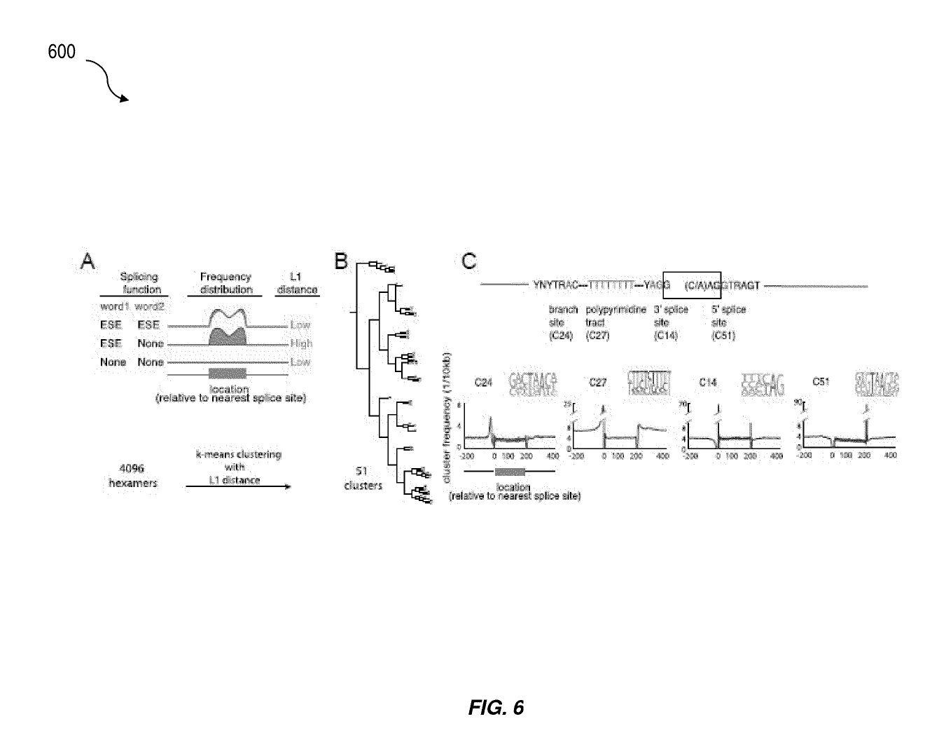

FIG. 6A-C illustrates clustering motifs according to their positional distribution around splice sites. The positional distributions of all 4096 possible hexamers were plotted around a database of human splice sites. FIG. 6A shows several comparisons of two hypothetical hexamers (word 1 and word 2) are drawn to illustrate three different scenarios. L1 distance (shaded area) is used to compare normalized frequency distributions. Low L1 distance indicates there are small differences between two positional distributions and the two hexamers have the same or no difference in splicing function. High L1 distance denotes the two positional distributions are vastly different and likely differ in their role in splicing. FIG. 6B shows that L1 distance was used to cluster the hexamers into 51 distinct groups based on the shape of their positional distributions around splice sites. The clusters that correspond to the canonical splicing elements are indicated in red. FIG. 6C shows the arrangement of these elements on a prototypical pre-mRNA is annotated on the exon diagram. Hexamers within these clusters were aligned into motifs. Average occurrence frequencies of the entire cluster's hexamer were calculated at each position around the splice site database.

The overall goal of this method was to cluster hexamers into subsets that shared a similar positional distribution. This clustering required a method for pairwise comparison of two shapes. The difference in positional distribution shapes between two hexamers was calculated by determining L1 distances between all possible pairwise combinations of these 4096 vectors (FIG. 6A). In a graph of normalized hexamer counts, L1 distance is simply the area between two positional distributions. These L1 distances were used to cluster (k-means) the hexamers into 51 distinct groups. The optimal value of k was determined by the CH index. The hexamers within each cluster were aligned without gaps. The resulting motifs returned by this analysis had distinct positional distributions around the 3′ and 5′ss.

An immediately obvious feature of all 51 clusters was the sequence similarity between the hexamers that clustered together. In other words, hexamers that were highly similar in positional distribution were also highly similar in sequence. Hamming distance (i.e. the number of shifts or mismatches in the optimal ungapped alignment of two hexamers) was used to compare the sequence similarity of hexamers within a cluster. Intracluster similarity of hexamer sequence was much higher than expected by chance (all p values<0.01; 1000 trials per cluster, 51 clusters). As there is no a priori reason for similar sequences to share similar positional distributions relative to splice sites, it can be interpreted that the strong sequence motifs found in the clusters as binding motifs of splicing factors that function at an optimal distance from a splice site. Consistent with this observation, motifs are found that match the known canonical splicing elements (i.e. branch point, polypyrimidine tract, 3′ss and 5′ss) at the correct location relative to exon/intron boundaries. Cluster 24 peaks at position −26 nt and represents the branchpoint sequence with a core TRAY motif flanked by extended complimentarily to U2snRNA (i.e. 4 nucleotides upstream and 3 nucleotides downstream of the bulged A). It is important to note that the motif returned by this algorithm is a far better fit to the known mechanism of U2 snRNA mediated branch point recognition than motifs built from alignments of experimentally defined branchpoints. Similarly, the 5′ss motif (cluster 51 in FIG. 2C) contains GTAAGT—a perfect stretch of complementarity to the mammalian U1 snRNA. Interestingly, this motif is avoided in the downstream exon proximal to the bona fide 5′ss. The polypyrimidine tracts are U-rich and covered by several clusters. A motif identical to the U2AF65 SELEX result of FIG. 1A was found. The 3′ss AG and the polypyrimidine tract cluster separately presumably because of the variable spacing often found between these elements in natural splicing substrates and because they are recognized by separate factors.

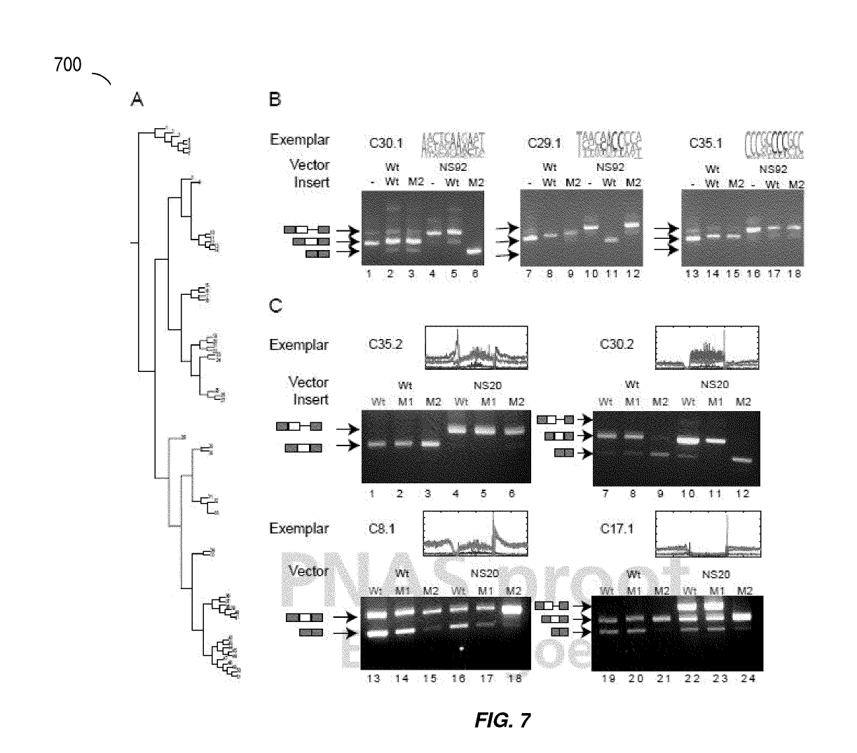

Point mutations that create mutant hexamers with large L1 distances from wildtype hexamers alter splicing in vivo. In order to validate elements from different clusters in vivo we assayed their effect on exon inclusion in a variety of splicing reporter minigenes. Test cases (exemplars) chosen to represent a cluster were cloned into reporter constructs, transfected into 293 cells and assayed by RT-PCR. To determine if the positional distribution distance measurements used in the clustering were predictive in identifying substitutions that disrupt a splicing element, point mutations were selected based on the degree to which they shifted the intra-allelic L1 distance of the insert. There are eighteen different point mutations that can be introduced into a hexamer. Each of these mutations creates a new hexamer with a different positional distribution around splice sites. Substitutions with a large L1 distance were predicted to be most likely to disrupt splicing. Ranking all possible point mutations by L1 distance we found the top 25% to have twice as many ESE or ESS changing mutations than the bottom 25% of this ranked list. L1 distance was used to design predicted splicing mutants for functional analysis in splicing reporter constructs (see FIG. 6C). This analysis was performed for exemplars drawn from three clusters that represented novel splicing elements. For all three exemplars, the inserts and mutants spliced normally when ligated into the vector that contained wildtype splice sites as shown in FIG. 7B, lanes 2, 3, 8, 9, 14 and 15. However when introduced into the context of mutation NS92 where the test exon was weakened by a mutation in the 5′ss, two of the three wildtype/mutant pairs displayed divergent splicing phenotypes (i.e. the wildtype sequence spliced differently than the predicted point mutant for cluster 30 and cluster 29—FIG. 7B lanes 5, 6, 11 and 12). Neither the wildtype nor the mutant of cluster 35 affected splicing (C35.1 in FIG. 7B). To see if the results observed in the mutant context of NS92 were general, the assay was repeated with different cluster exemplars (C35.2 and C30.2 in FIG. 7C) and different mutant context (NS20—weakened polypyrimidine tract) with identical results. This consistency between exemplars across different conditions suggested that the clusters are effectively characterizing the splicing activity of sequence elements. It is, however, possible that any variation in the sequence would disrupt this splicing activity. To establish the specificity of this prediction we tested variations that would be predicted to be neutral (i.e. variations in the same hexamer which results in low L1 distances). In all cases examined, these negative control (M1) mutants were spliced similarly to wildtype inserts in the splicing assay. The wildtype splicing pattern was similar to the predicted neutral mutant (FIG. 7C lanes 7, 8 and lanes 10, 11). The mutation with high L1 distance was spliced differently than both the wildtype and predicted neutral mutations (FIG. 7C, lane 9 versus lane 7, 8).

Exemplars were also selected from two additional clusters that represent a variety of intronic splicing enhancers (i.e. positional distributions are enriched in the intronic regions). The predicted neutral mutants (M1) were spliced similarly to wildtype (FIG. 7C comparing lanes 13 and 14, 16 and 17, 19 and 20, 22 and 23), whereas the change-of-function mutants (M2) were spliced differently (FIG. 7 C comparing lanes 13 and 15, 16 and 18, 19 and 21, 22 and 24). In both cases, mutating an intronic element in the exon exhibited positive splicing phenotypes.

FIG. 7A-C shows minigene assay of element function confirms splicing differences between wildtype cluster exemplars and predicted mutants. FIG. 7A shows the clusters selected for functional analysis are indicated in red. FIG. 7B shows exemplars drawn from each cluster are tested with their variants and “no insert” controls in several splicing reporter constructs. Total RNA from transfection into 293 cells was analyzed by RT-PCR. Arrows indicate the nature of the splicing product. M2 denotes the point mutant with the highest intra-allelic L1 distance predicted to be most deleterious to the splicing function of the wildtype insert. FIG. 7C Additional exemplars for clusters 30 and 35, along with exemplars for clusters 8 and 17 were used to contrast the effect of predicted neutral mutations (M1) or the effect of predicted change-of-function mutations (M2) with wildtype splicing. The M2 Mutation is the variation with the highest intra-allelic L1 distance, and the negative control, the M1 mutation, has the lowest intra-allelic L1 distance.

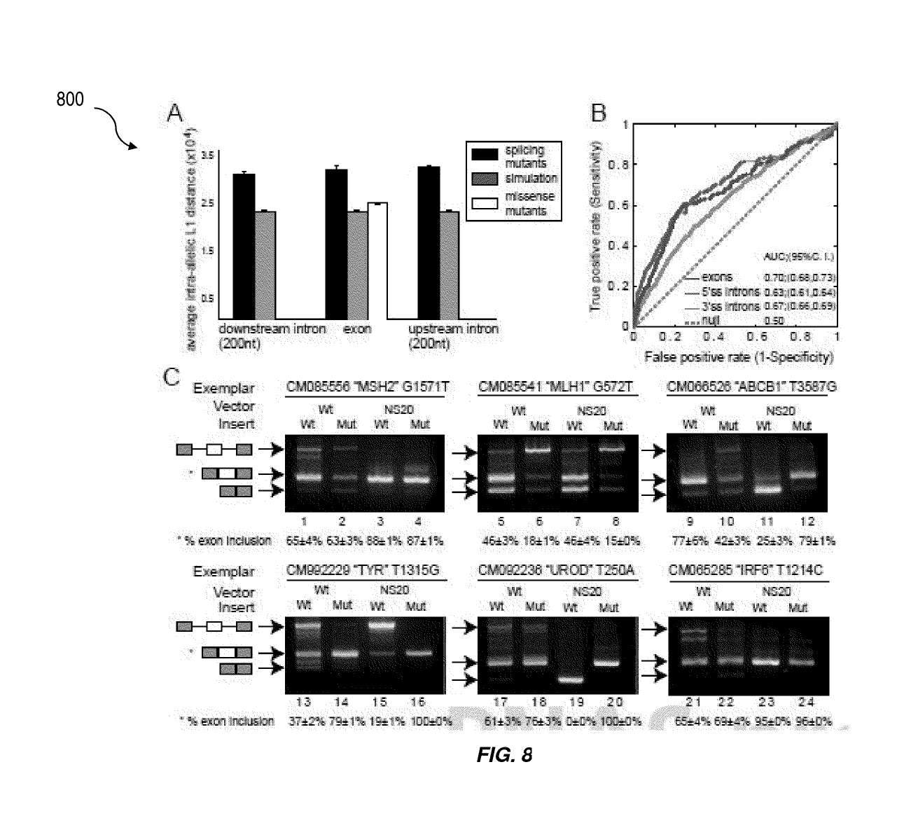

High intra-allelic distance is predictive of splicing mutations. To test the predictive power of using intra-allelic L1 distance to discover splicing mutations, the intra-allelic L1 distances of splicing mutations that were downloaded from the HGMD were computed. Disease-causing alleles specifically associated with splicing exhibited significantly higher L1 distances than simulated mutations (p-value<0.001 for the upstream intron, exon, and downstream intron) (FIG. 8A). The simulation incorporated mutational bias towards transitions. Interestingly missense disease alleles downloaded from HGMD also displayed a significantly higher intra-allelic L1 distance than expected (p-value<0.001). This data suggests that even human disease alleles located outside of the canonical splice sites are more likely to cause aberrant splicing than natural variations that do not cause disease. It was roughly estimated the fraction of splicing mutants by modeling the missense category of HGMD mutations as a mixture of exonic HGMD mutations that are known to cause splicing defects and simulated mutations (which are presumed not to cause splicing defects). In other words, a hypothetical set comprised of 78% simulated mutations and 22% splicing mutants had the same average intra-allelic L1 distance as the HGMD missense mutants. Accounting for these mutants along with HGMD entries that were formally classified as splicing mutants suggested that about a third of all disease causing mutations display some sort of aberrant splicing phenotype. To explore the usefulness of L1 distance in predicting splicing mutations, ROC curve analysis was performed, comparing the true to false positive rates at different thresholds of L1 (FIG. 8B). The ROC curve analysis suggests that an L1 prediction threshold that can identify 50% of the exonic splicing mutations in a sample (i.e. y≈0.50 in FIG. 8B), would also return 20% false positives (i.e. x≈0.2). This analysis demonstrated that the model was significantly predictive of splicing mutants—especially 5′ss and exonic mutants (FIG. 8B). As the later category of exonic mutants falls outside of the well defined canonical splice sites, there are few other options to evaluate the effect of mutations. This method could be applied to finding splicing mutations in exons. To investigate this idea that missense mutations disrupt splicing, six missense mutations with high L1 distances in the minigene splicing assay were tested (FIG. 8). RT-PCR analysis of these exemplars uncovered an obvious difference in splicing between wildtype and mutant inserts in five of the six exemplars tested (FIG. 8C). This data confirmed the presence of processing mutations in exonic mutations. A web interface has been written to facilitate the analysis of variations in human pre-mRNA (http://fairbrother.biomed.brown.edu/data/mutations).

FIG. 8A-C illustrates that human disease alleles are predicted to disrupt splicing. FIG. 8A shows average intra-allelic L1 distances for each category of mutation (HGMD splicing and HGMD missense/nonsense) and their corresponding background models of simulated mutations divided by location with respect to the splice sites. Error bars denote 95% confidence intervals. FIG. 8B shows receiver operating characteristic (ROC) curve analysis using HGMD splicing mutants in regions around the 3′ss and 5′ss as “true positives” and simulated mutations as “true negatives.” The ROC curve is a fundamental tool for diagnostic test evaluation. In a ROC curve the true positive rate (Sensitivity) is plotted in function of the false positive rate (100-Specificity) for different cut-off points of a parameter. Each point on the ROC curve represents a sensitivity/specificity pair corresponding to a particular decision threshold. The area under the ROC curve is a measure of how well a parameter can distinguish between two diagnostic groups (diseased/normal). ROC curve analysis classifies these mutations at decreasing thresholds of L1 stringency plotting the false against true positive rates. The exonic region is shown; upstream and downstream intronic regions are shown. FIG. 8C shows exemplars that were selected from the HGMD missense mutants with the highest intra-allelic L1 distance. Total RNA from transfection into 293 cells was analyzed by RT-PCR. The HGMD ID, gene name, and the mutational position are shown for each experiment. Quantifications on exon inclusion products are also shown. Arrows indicate the identity of the splicing product.

Known splicing elements occupy distinct clusters. In the output of the clustering, the canonical splicing elements segregated into discrete clusters. Strong 5′ss motifs (cluster 51) and 3′ss motifs (cluster 14) emerged as independent clusters. The hexamers in cluster 27 represented the polypyrimidine tract with their well-characterized signal located 4 to 20 nucleotides upstream of the 3′ss (FIG. 6C). Clusters 23 and 24 both appeared to fit the T(A/G)A(C/T) of the eukaryotic branchpoint sequence. Exonic splicing enhancers (ESE) mostly fell within 5 clusters (clusters 29-33, FIG. 6B). Further sorting the ESE hexamers into five prime specific ESEs, 3′ splice site ESEs and shared ESEs revealed that ESEs specific to the 3′ss fell mostly within cluster 30 and the smaller 5′ss specific ESEs segregated into cluster 29. In addition to ESEs, a variety of intronic splicing enhancers (ISEs) could be recognized within the cluster results. A prominent ISE, the G triplet, was found in cluster 8. We found G triplets and C triplets to possess distinct non-overlapping positional distributions around human splice sites (compare cluster 8 to cluster 35). While both C and G triplets have a predominantly intronic positional distribution, C triplets tend to occur closer to the splice sites than G triplets. C triplets could be a recognition element for a protein like hnRNP C. Like many intronic enhancers, both C and G triplets occur at lower frequency on the exonic side of splice sites suggesting that they are not tolerated in the constitutively spliced exons that comprise the majority of the database used in this study. It was not found that mutations in exonic C triplets alter their effect on splicing (FIG. 7). C triplets may require other splicing elements for their activity and cannot function in isolation in a minigene. One candidate for this auxiliary element is the G triplet as these elements co-occur. C triplets are predominantly located upstream of the 3′ss, roughly around 30 nucleotides downstream of the local G triplet peak. Across the database, 22% of introns have G triplets between positions −65 and −50 relative to the 3′ss. If the intron contains a C triplet, the likelihood of a G triplet increases from 22% to 34% (p-value≈0, chi-square test). It is possible that this co-occurrence may reflect a function synergy such as their potential to form structure or a larger RNP complex through their trans-acting factors.

The general observation of intronic motifs that increase in frequency with decreasing distance to the splice site and then decrease in frequency when approaching the splice site from the exonic side is not consistent across all motif classes. Certain motifs (cluster 17) appear to increase in frequency with decreasing distance to the splice sites on both the intronic and exonic side of the junction. This type of distinction would not have been discovered by previous computational approaches. One possible explanation for this outlier might be that this motif is not an RNA element but rather a recognition element for a DNA binding protein. Polymerase pausing and chromatin formation with specific histone modifications are two DNA binding phenomena that have been implicated in enhanced splicing. A/T rich elements are often found in recognition sites of DNA bending proteins or could form the weak RNA:DNA duplexes that promote the polymerase backtracking associated with some types of transcriptional pauses.

It has been demonstrated that mutations that are disruptive to positional distribution are disruptive to splicing. Evidence has been found that missense mutations that cause human disease are more likely to disrupt splicing than simulated mutations. Because of the difficulty of assaying splicing in patients, very little is known about the prevalence of splicing defects in human disease. About 15% of the mutations in the HGMD are described as splicing mutants. Some have been validated directly but many of these mutations co-localize with critical regions of splice sites and so are assumed to disrupt splicing. A more problematic class of identification is the set of mutations that fall outside of well-defined sites. It is possible that many of these disease alleles are associated with subtle defects in splicing that could exacerbate the disease phenotype. Using an approach that models the missense mutations as a mixture of exonic splicing mutants and simulated mutations, we estimate that 22% of missense disease alleles alter splicing. A reanalysis of missense mutations supports the notion that many disease alleles originally classified as missense also disrupt splicing. This class of “undiagnosed” splicing mutations along with known splicing mutations predicts that about one third of all mutations alter splicing.

It can be important to be able to identify the many human disease alleles that alter splicing and characterize missense mutations for their effect on pre-mRNA processing. New molecular therapies that correct splicing defects may ameliorate many genetic disorders. The ability to correctly identify splicing mutations by their elevated L1 distance and the ability to predict mutations in the minigene system demonstrate that this is a useful tool in predicting causal alleles.

RNA probes were T7 transcribed from DNA oligos with incorporating ³²P label and incubated in HeLa nuclear extract pre or mock treated with MC2 antibody. Label transfer was visualized by phosphoimager following PAGE. RNA elements were also tested for function in variations of the pZW4 splicing reporter minigene (i.e. FIG. 5 and “wt” vector in FIG. 8). Additional constructs with variations characterized as splicing mutations in prior reports were designed as sensitized reporters. Inserts were selected on the basis of their match to the cluster motif. The most extreme difference between wild type and mutant hexamers represents M2, the point mutation that the method would predict most likely to disrupt a motif. Conversely, the most similar positional distributions, M1, would be predicted to function similarly to the wild type sequence. These variations were introduced into the reporter, transfected into 293 cells and assayed by RT-PCR. Both alleles of missense mutations were tested with 15 nt of flank as a 31-mer ligated into the minigene.

The positional distributions of all 4096 hexamers were plotted around a dataset of human splice sites. Normalized counts were compared via the L1 distance metric for all pairwise combinations of hexamers. The data was clustered using the CH index to determine an optimal value k=51 for K-means clustering. In FIGS. 7 and 8, for a given point mutation the representative L1 distance was taken to be the largest intra-allelic distance of the 6 distances calculated by comparing each tiled wildtype hexamer with its mutant counterpart. L1 distances were calculated in this way for the 8,027 disease-causing splicing mutations and 42,532 missense/nonsense mutations downloaded from the HGMD. Simulated mutations (preserving a two fold higher bias towards transitions) were used to generate background mutations. ROC curves were generated in MATLAB on a mutation set which contained equal quantities of background mutations and true positives (HGMD splicing mutants).

### Example 2

It was previously demonstrated that splicing elements are positional dependent. This relationship between location and function is exploited by comparing positional distributions between all possible 4096 hexamers around a database of human splice sites. The distance measure used in this study found point mutations that produced higher distances disrupted splicing, whereas point mutations with smaller distances generally had no effect on splicing. Reasoning the idea that functional splicing elements have signature positional distributions around constitutively spliced exons, Spliceman is introduced—an online tool that predicts how likely distant mutations around annotated splice sites were to disrupt splicing. Spliceman takes a set of DNA sequences with point mutations and returns a ranked list to predict the effects of point mutations on premRNA splicing. The current implementation included the analyses of 12 genomes: human (hg18 and hg19), chimp (panTro2), rhesus (rheMac2), mouse (mm8), rat (rn4), dog (canfam2), cat (felCat3), chicken (galGa13), guinea pig (cavPor3), frog (xenTro2), and zebrafish (danRer3).

Pre-mRNA splicing is an important regulatory step in gene expression pathway: introns are removed and exons are joined to form mRNA. The splicing process is performed by the spliceosome, a macromolecular ribonucleoprotein complex that rivals the ribosome in size and complexity. The intricate assembly of the spliceosome is guided by the consensus splice site sequences (i.e. branch point, polypyrimidine tract, 3′ and 5′ splice sites) and a family of subsidiary elements known as intron and exon splicing enhancers and silencers. Estimates of the fraction of disease mutations that cause aberrant splicing had been reported to range from 15% to 62%.

It has been demonstrated that splicing elements had signature positional distributions around constitutively spliced exons—they were abundant where they functioned positively and rare when they were inhibitory. These positional properties were captured for hexamers with the L1 distance metric and used it to cluster positional distributions of all possible 4,096 hexamers around human splice sites. In addition to recognizing consensus splice site sequences, our method successfully identified various classes of intronic and exonic splicing enhancers and silencers. Experimental verifications of the computational results strongly indicated the power of this method to be predictive. Specifically, point mutations were found that produced higher L1 distances disrupted splicing in an in vivo minigene system, whereas point mutations with small distances generally had no affect on splicing. To facilitate the analysis of splicing mutations, we present Spliceman—an online tool that predicts how likely a genomic variation is to disrupt splicing. While the effect of mutations found in the consensus splice donor and acceptor sites can often be predicted with high accuracy, Spliceman focuses in predicting distant splicing enhancers and silencers.

The computational engine and web interface were developed in Perl and with the use of Bioperl toolkit. The tool was designed to accept either a set of genomic variants or DNA sequences with mutational data in FASTA format.

Exoh database of each species was built from Refseq annotations of the following assemblies stored at the UCSC Table Browser (Karolchik D. et. al. (2004) The UCSC Table Browser data retrieval tool. Nuc. Acid Res. 1:32(Database issue):D493-6): human (hg18 and hg19), chimp (panTro2), rhesus (rheMac2), mouse (mm8), rat (rn4), dog (canFam2), cat (felCat3), chicken (galGal3), guinea pig (cavPor3), frog (xenTro2), and zebrafish (danRer3). Duplicated entries were removed, and each sequence was divided into two distinct regions: upstream intron (up to 200 intronic and 100 exonic nucleotides of 3′ss) and downstream intron (up to 200 intronic and 100 exonic nucleotides of 5′ss). Therefore each sequence in the exon database contained at most 600 nucleotides. In the case where intronic or exonic sequence length was less than 400 or 200 nucleotides, respectively, the sequences were equally divided and each half was assigned to its nearest splice site.

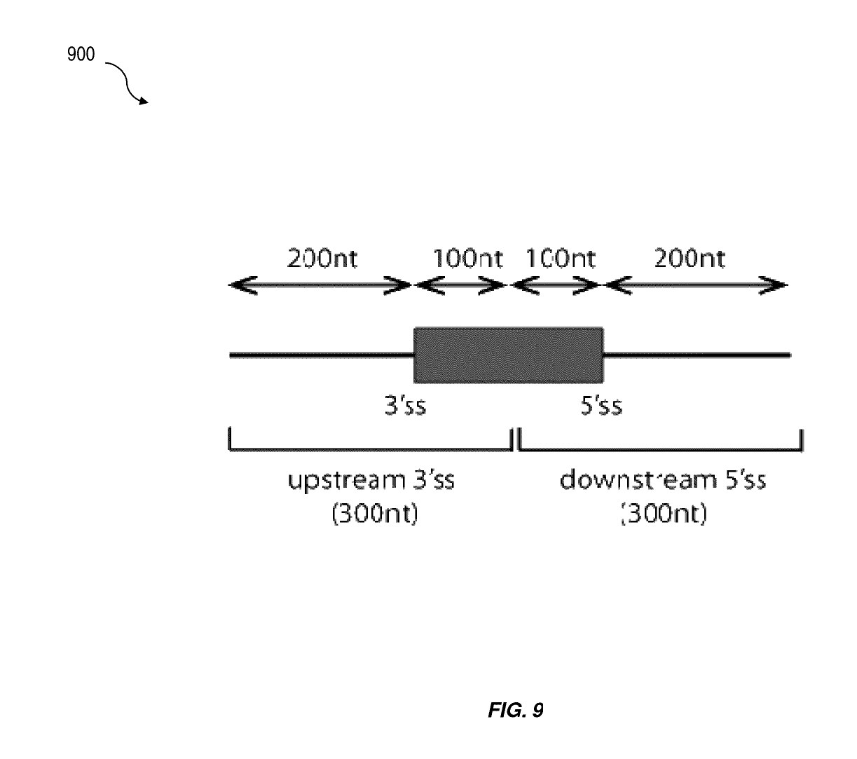

FIG. 9 illustrates a nucleic acid sequence and the corresponding location count in the feature vector. Intronic regions are represented in line and exonic region in box. In the case that intronic or exonic length was less than 400 or 200 nucleotides, respectively, the sequence was divided by half and each half was assigned to its nearest splice site

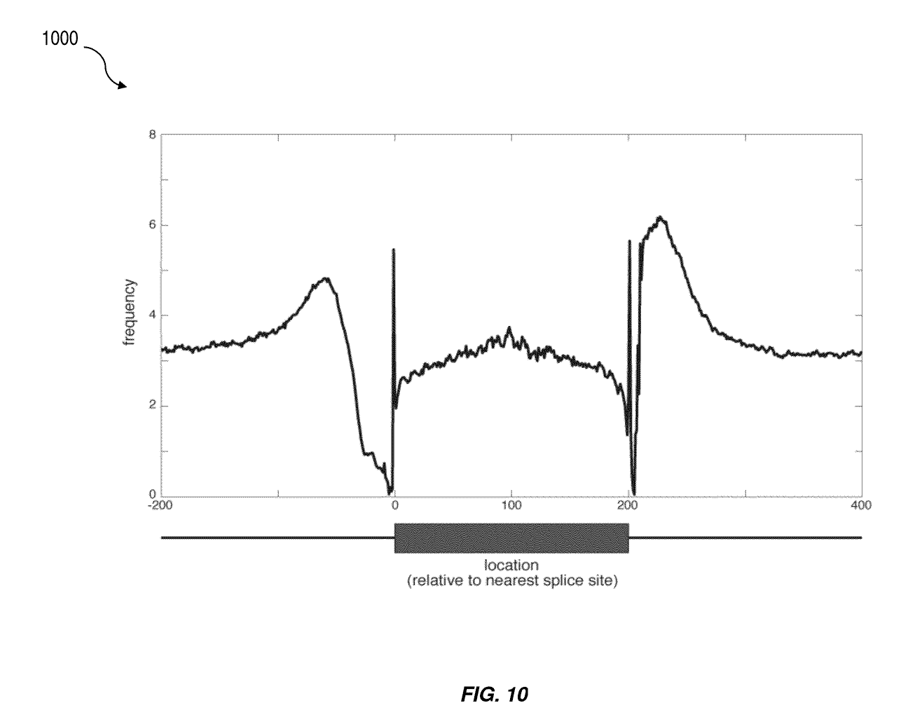

Word size was selected and feature vectors can be generated. RNA binding proteins typically contain one to four RNA recognition motif domains so that motifs recovered are expected to be of heterogeneous length. The analysis of prior SELEX studies indicated RNA binding proteins recognized motifs between the length of 6 to 10 nucleotides. Implementations of dictionary methods also illustrate how a smaller word size choice was generally self-correcting. For these reasons, as well as computation efficiency, hexamers (6 nucleotide sequences) for the analysis presented here. For each hexamer, the counting algorithm traversed through the exon database and recorded the occurrences of that hexamer at 600 different positions relative to splice sites. Repeated this procedure for all hexamers generated 4,096 feature vectors. Each feature vector highlights the enrichment and depletion characteristics of a hexamer at locations relative to splice sites. FIG. 10 is an illustration of an example positional distribution feature vector. Because overlapping occurrences of internally repeated words can occur more frequently than complex words, overlapping occurrences of any words were counted as a single occurrence in a window of 11. For example, a run of 11 A's (i.e. AAAAAAAAAAA) was counted as single occurrence at the position where it was first observed.

Quantifying similarities and differences between feature vectors by computing L1 distance metric can be performed. This tool used the L1 distance metric to quantify the “closeness” between two feature vectors. An obvious choice for distance metric is the Euclidean or L2 distance; however, the sharp peaks created by the splice site hexamers themselves dominated the comparison and prevented the detection of more subtle signals. This was remedied by using the Manhattan distance, also referred to as the city block distance or simply L1 distance. L1 distance was calculated as the sum of the absolute differences in feature vectors at each of the 600 positions. The higher the L1 distance between two hexamers (i.e. wild type vs. point mutation), the greater the differences are between them, thereby the mutation is predicted to be more likely to alter splicing. The L1 distance in this example can be computed according to:

$${d}_{1} ( p , q ) - \text{?} \vert {p}_{i} - {q}_{i} \vert$$

$$\text{?} \text{indicates text missing or illegible when filed}$$

Calculating percentile ranks for L1 distances can be performed. This method binned all possible L1 distances into 100 equal intervals and assigned each L1 distance to its corresponding bin (i.e. comparisons between two hexamers that resulted in low L1 distances would be assigned with low percentile ranks).

Spliceman takes a set of genomic variants or DNA sequences with point mutations and computes how likely these single nucleotide variants alter splicing phenotypes. For each genomic variant or mutation given in the input form, the tool reports the L1 distance and percentile rank that correspond to the given mutation. This is the rank that the tool predicts bow likely a mutation is to disrupt pre-mRNA splicing. The higher the percentile rank, the more likely the point mutation is to disrupt splicing.

It has been demonstrated the predictive power of the proposed method by clustering hexamers into distinct groups based on positional distributions. Experimental verifications suggested mutations with high L1 distances altered splicing, whereas mutations with low L1 distances generally had no affect on splicing. To further analyze the predictive power of this method, ROC curve statistics are computed using a binary classifier (‘0’ corresponds to true positive samples derived from a set of 618 confirmed splicing mutations found in the HGMD and ‘1’ corresponds to false positive samples constructed from a set of simulated mutations using equal rates of transversions and transitions). ROC statistics were computed for mutations found in three different regions (upstream 3′ss introns, exons, and downstream 5′ss introns). Since splice site sequences can often be predicted with high accuracy, we removed HGMD mutations that were located in the consensus splice donor and acceptor sites to measure the predictive power of this method on distant splicing enhancers and silencers. The Area Under Curve (AUC) measurements shows that the proposed method is predictive of distant splicing mutations (FIG. 8B).

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein do not require the particular order shown, or sequential order, to achieve desirable results. Other embodiments may be within the scope of the following claims.

What is claimed is:

1. A method of predicting the effect of a mutation, in a nucleic acid sequence on splicing, the method comprising:
determining a distance between at least two nucleic acid sequence positional distributions;
providing a prediction of impact on splicing function based on at least the distance, wherein a low distance indicates there is little or no difference in splicing function compared to a normal control, and wherein a high distance indicates a difference in splicing function.

2. The method of claim 1, wherein the distance is high when the distance is greater than about 95% of distances between a representative set of nucleic acid sequence positional distributions that can occur through the process of a single point mutation.

3. The method of claim 1, wherein the at least two nucleic acid sequences comprises a messenger ribonucleic acid (mRNA) sequence, pre-mRNA sequence, cDNA sequence, or genomic DNA sequence.

4. The method of claim 1, wherein the distance is a L1 distance, computed according to:
$$d ( p , q ) = {\sum }_{i = 1}^{n} \vert {p}_{i} - {q}_{i} \vert$$
wherein p is a normalized count of one of the at least two nucleic acid sequence positional distributions at position n, q is a normalized count of another of the at least two nucleic acid sequence positional distributions at position n, and n is a genomic position relative to a splice site.

5. The method of claim 3, wherein the genomic position is determined by a number of nucleotides in a sequence from the splice site.

6. The method of claim 4, wherein n is between about 1 and about 600.

7. The method of claim 1, wherein the at least two nucleic acid sequence positional distributions include both intronic and exonic positions.

8. The method of claim 1, wherein said splicing mutation is a point mutation or a missense mutation or a single nucleotide polymorphism.

9. The method of claim 1, wherein the distance is an intra-allelic distance.

10. The method of claim 1, wherein said splicing mutation is a disease-causing splicing mutation.

11. The method of claim 1, further comprising:
determining a likelihood the splicing mutation is a disease-causing splicing mutation.

12. The method of claim 1, wherein the distance is a Euclidian distance.

13. The method of claim 1, wherein the length of each of the at least two nucleic acid sequences is between about 6 and about 10.

14. The method of claim 1, wherein the length of each of the at least two nucleic acid sequences is 6.

15. The method of claim 1, wherein the at least two nucleic acid sequence positional distributions are computed from the genome of one or more of the following organisms: human, chimp, rhesus, mouse, rat, guinea pig, cat dog, chicken, X. tropicalis, and zebrafish.

16. A non-transitory computer readable storage medium comprising executable instructions to:
receive data characterizing a first nucleic acid sequence, a second nucleic acid sequence, a positional distribution of the first sequence relative to a splice site, and a positional distribution of the second sequence relative to the splice site;
compute a distance between the positional distribution of the first sequence and the positional distribution of the second sequence, the second sequence being a mutation of the first sequence; and
provide the distance.

17. The computer readable storage medium of claim 16, further comprising executable instructions to:
predict, from the distance, the effect of the mutation on splicing function, wherein a low distance indicates there is little or no difference in splicing function compared to a normal control, and wherein a high distance indicates a difference in splicing function.

18. The computer readable storage medium of claim 16, wherein the first and second nucleic acid sequences each comprise a messenger ribonucleic acid (mRNA) sequence, pre-mRNA sequence, cDNA sequence, or genomic DNA sequence.

19. The computer readable storage medium of claim 16, wherein the distance is a L1 distance, computed according to:
$$d ( p , q ) = {\sum }_{i = 1}^{n} \vert {p}_{i} - {q}_{i} \vert$$
wherein p is a normalized count of one of the first nucleic acid sequence positional distribution at position n, q is a normalized count of the second nucleic acid sequence positional distribution at position n, and n is a genomic position relative to a splice site.

20. The computer readable storage medium of claim 19, wherein the genomic position is determined by a number of nucleotides in a sequence from the splice site.

21. The computer readable storage medium of claim 20, wherein n is between about 1 and about 600.

22. The computer readable storage medium of claim 16, wherein the first nucleic acid sequence positional distribution and the second nucleic'acid sequence positional distribution include both intronic and exonic positions.

23. The computer readable storage medium of claim 16, wherein the mutation is a point mutation or a missense mutation or a single nucleotide polymorphism.

24. The computer readable storage medium of claim 16, wherein the distance is an intra-allelic distance.

25. The computer readable storage medium of claim 16, wherein said mutation is a disease-causing splicing mutation.

26. The computer readable storage medium of claim 16, further comprising:
determining a likelihood the mutation is a disease-causing splicing mutation.

27. The computer readable storage medium of claim 16, wherein the distance is a Euclidian distance.

28. The computer readable storage medium of claim 16, wherein the length of the first nucleic acid sequence and the second nucleic acid sequence is between about 6 and about 10.

29. The computer readable storage medium of claim 16, wherein the length of the first nucleic acid sequence and the second nucleic acid sequence is 6.

30. The computer readable storage medium of claim 16, wherein the first nucleic acid sequence positional distribution and the second nucleic acid sequence positional distribution are computed from the genome of one or more of the following organisms: human, chimp, rhesus, mouse, rat, guinea pig, cat dog, chicken, X. tropicalis, and zebrafish.

31. A tangible computer readable medium including instructions that, when executed by a computer, cause the computer to:
create alignments of nucleotides surrounding all 3′ and 5′ splice sites;
count the number of occurrences of all polymers;
construct, for each polymer, a feature vector by concatenating counts from the 3′ splice site alignment and the 5′ splice site alignment;
normalize the counts in each entry of each feature vector;
cluster the feature vectors; and
determine the number of clusters.

32. The tangible computer readable medium of claim 31 wherein the instructions are further configured to cause the computer to construct the feature vector according to:
$$∀ x ∈ \vec{x} , {x}^{′} = \frac{x - μ}{σ}$$
where x are the counts, μ is the average count in the region, and σ is the standard deviation.

33. The tangible computer readable medium of claim 31 wherein the clustering includes comparing all possible pairs of vectors, position by position, and returning a distance metric that is related to the closeness of the two vectors.

34. The tangible computer readable medium of claim 31 wherein the clustering includes using a distance metric to organize data into groups of similar vectors.

35. The tangible computer readable medium of claims 33 wherein the distance metric is a Euclidian distance.

36. The tangible computer readable medium of claims 33 wherein the distance metric is a Manhattan distance calculated according to:
$$d ( p , q ) = {\sum }_{i = 1}^{n} \vert {p}_{i} - {q}_{i} \vert$$
wherein p is a normalized count of a first polymer at position n, q is a normalized count of a second polymer at position n, and n is a genomic position relative to a splice site.

37. The tangible computer readable medium of claim 31, wherein polymers include between about 6 and about 10 nucleotides.

38. The tangible computer readable medium of claim 31 wherein the instructions are further configured to cause the computer to rank and compare the distance metric with a neighborhood inference set of exonic splicing enhancers.

39. The tangible computer readable medium of claim 31 wherein the length of each feature vector is 600 nucleotides.

40. The tangible computer readable medium of claim 31 wherein the feature vectors are clustered using a k-means algorithm and the distance metric.

41. The tangible computer readable medium of claim 31 wherein the instructions are further configured to cause the computer to:
for exons less than 200 nucleotides, divide the exonic sequence in half and assign it to the closest splice site; and
for introns less than 400 nucleotides, divide the intronic sequence in half and assign it to the closest splice site.

42. A method for identifying a candidate subject for repair of a gene splicing defect associated with a pathological condition, comprising
providing a plurality of nucleic acid sequences obtained from or derived from an individual or a gene mutation database sequence and at least one corresponding mutation for each nucleic acid sequence;
providing a positional distribution of each of the plurality of nucleic acid sequences and the at least one corresponding mutation;
determining a distance between each of the nucleic acid sequence positional distributions and the at least one corresponding mutation positional distribution, wherein a low distance indicates there is little or no difference in splicing function, and wherein a high distance indicates a splicing mutation in the nucleic acid sequence and identifies said individual as a candidate for repair of said gene splicing defect.

43. The method of claim 42, wherein said individual is suffering from, suspected of having, or has a family history of a hereditary disease.

44. The method of claim 43, wherein said hereditary disease is selected from the group consisting of cancer, heart disease and stroke, diabetes, osteoporosis, depression, and Alzheimer's Disease.

45. The method of claim 42, wherein said gene mutation database comprises the Human Gene Mutation Database (HGMD).

46. The method of claim 44, wherein said cancer comprises breast, ovarian, colorectal, prostate, or skin cancer.

47. The method of claim 42, further comprising prioritizing a plurality of said splicing mutations to predict clinical significance.


SEQUENCE LISTING (6 sequences)

SEQ ID NO: 1 - DNA, 10 bp, Artificial Sequence
  binding motif of U2AF65
ygttyttnnn

SEQ ID NO: 2 - DNA, 11 bp, Artificial Sequence
  motif of cluster 27 splicing element
yyyhybyyyyt

SEQ ID NO: 3 - DNA, 11 bp, Artificial Sequence
  motif of cluster 30.1 exemplar
annnvradhnh

SEQ ID NO: 4 - DNA, 11 bp, Artificial Sequence
  motif of cluster 29.1 exemplar
thhmhmyyhhh

SEQ ID NO: 5 - DNA, 11 bp, Artificial Sequence
  motif of cluster 35.1 exemplar
cccvbyyyvks

SEQ ID NO: 6 - DNA, 11 bp, Artificial Sequence
  the equivalent of a single occurrence at a position where the sequence is observed
aaaaaaaaaaa